(19) United States
(12) Patent Application Publication
(10) Pub. No.: US 2024/0044269 A1
(43) Pub. Date: Feb. 8, 2024

(54) VALVE GROUP

(71) Applicant: UFI FILTERS S.P.A., Porto Mantovano, Mantova (IT)

(72) Inventor: Giorgio GIRONDI, Porto Mantovano, Mantova (IT)

(21) Appl. No.: 18/258,551

(22) PCT Filed: Dec. 16, 2021
(86) PCT No.: PCT/IB2021/061829

§ 371 Date: Jun. 20, 2023

(30) Foreign Application Priority Data
Dec. 21, 2020 (IT) 102020000031661

(51) Int. Cl. F01M 5/00; F01M 1/10; F16K 31/00; F01M 1/02

(52) U.S. Cl. CPC F01M 5/005; F01M 1/10; F16K 31/002; F01M 1/02

(57) ABSTRACT

A valve group extending along a conduit and conduit axis includes conduit side walls and first and second axially spaced conduit openings, fluidically connected to operating and heat exchanger groups. The valve group includes a valve body with an axial guide slot, having a body cavity, and first and second body openings axially spaced apart, facing the first and second conduit openings. A shutter includes an axially movable shutter body between the valve body and conduit side walls. The shutter includes first and second shutter openings and a guide element extending radially through the guide slot. A control device engages the valve body and the shutter to control an axis between a base position in which a first hydraulic passage section is at least as great as a second hydraulic passage section, and an adjustment position in which the first passage section is smaller than the second passage section.

### FIELD OF APPLICATION

The present invention relates to a valve group for a pressurized oil circuit of a vehicle. Furthermore, the present invention relates to an oil management assembly of a vehicle, forming part of the pressurized oil circuit, comprising said valve group.

### BACKGROUND ART

It is well known that there is a multiplicity of fluid circuits in a vehicle in which predefined amounts of oil flow. Such circuits have the purpose of putting a plurality of distinct components or operating groups included in a vehicle in fluid communication. For example, the engine group or the transmission group are typically served by oil for adjusting the temperature thereof and/or the lubrication of the respective moving components.

The oil in the vehicle is subjected to a pumping or suction action which puts it into circulation, while being subjected to other specific operations, for example varying the temperature thereof or cleaning and filtration. Such operations are performed by specific operating groups with specific features.

Specific oil management assemblies are also known which are suitable for comprising one or more of the aforesaid operating groups by placing them in fluid communication with one another or by placing them in fluid communication with other vehicle operating groups, such as for example the engine group or the transmission group.

In fact, such oil management assemblies are typically operatively connected to fundamental and specific vehicle components or operating groups for which the features of the oil are of substantial importance: for example, to the engine group, or to the gearbox group (automatic type), or to the transmission group.

Therefore, as a function of the type of operating groups included, the oil management assemblies are suitable for managing the features of the oil, for example by varying the temperature or by performing specific filtration operations. Therefore, effectively managing the oil and the features thereof is extremely important for the correct and effective operation of the vehicle itself and of the fundamental vehicle operating groups served by the pressurized oil circuit.

In the state of the art, solutions of valve groups and oil management assemblies are well known in which different situations and different operating conditions of the oil and the management thereof have been addressed, for example the correct management of the temperature thereof and/or the filtration and cleaning thereof.

However, in the known embodiments, the respective valve groups fail to be safe and effective as the viscosity of the oil varies. In other words, it has been observed that some embodiments of valve groups incur breakage and/or malfunctions due to situations in which the oil has a high viscosity.

### Solution of the Invention

The need is therefore strongly felt to provide a valve group which solves the aforesaid technical problem.

It is the object of the present invention to provide a valve group suitable for being highly stable and ensure high resistance even in the presence of high viscosity oil, obviously without affecting the correct management of the oil flow.

Such an object is achieved by the valve group claimed in claim 1, by the pressurized oil circuit comprising said valve group in accordance with claim 22, and by an oil management assembly comprising the valve group in accordance with claim 23. The claims dependent on the aforesaid claims show preferred variants implying further advantageous aspects.

### DESCRIPTION OF THE DRAWINGS

Further features and advantages of the invention will become apparent from the description provided below of preferred exemplary embodiments thereof, given by way of non-limiting example, with reference to the accompanying drawings, in which:

FIGS. 1a, 1b, 1c, 1d, 1e, 1f, 1g, 1h, 1k, 1i, 1i′, 1l, 1l′ and 1m diagrammatically show different specific embodiments of an oil circuit comprising a valve group according to the present invention;

FIG. 2 shows a view with separate parts of a valve group according to the present invention, according to a first embodiment;

FIG. 3 shows the valve group in FIG. 2 in an assembled view;

FIGS. 4a and 4b show a sectional view of the valve group in FIG. 3, housed in a conduit, in which the shutter is positioned in a base position and in an adjustment position;

FIG. 5 shows a view with separate parts of a valve group according to the present invention, according to a second embodiment;

FIG. 6 shows the valve group in FIG. 5 in an assembled view;

FIGS. 7a, 7b and 7c show a sectional view of the valve group in FIG. 6, housed in a conduit, in which the shutter is positioned in a base position, in an adjustment position and in a safety position;

FIG. 8 shows a view with separate parts of a valve group according to the present invention, according to a third embodiment;

FIG. 9 shows the valve group in FIG. 8 in an assembled view;

FIGS. 10a and 10b show a sectional view of the valve group in FIG. 9, housed in a conduit, in which the shutter is positioned in a base position and in an adjustment position.

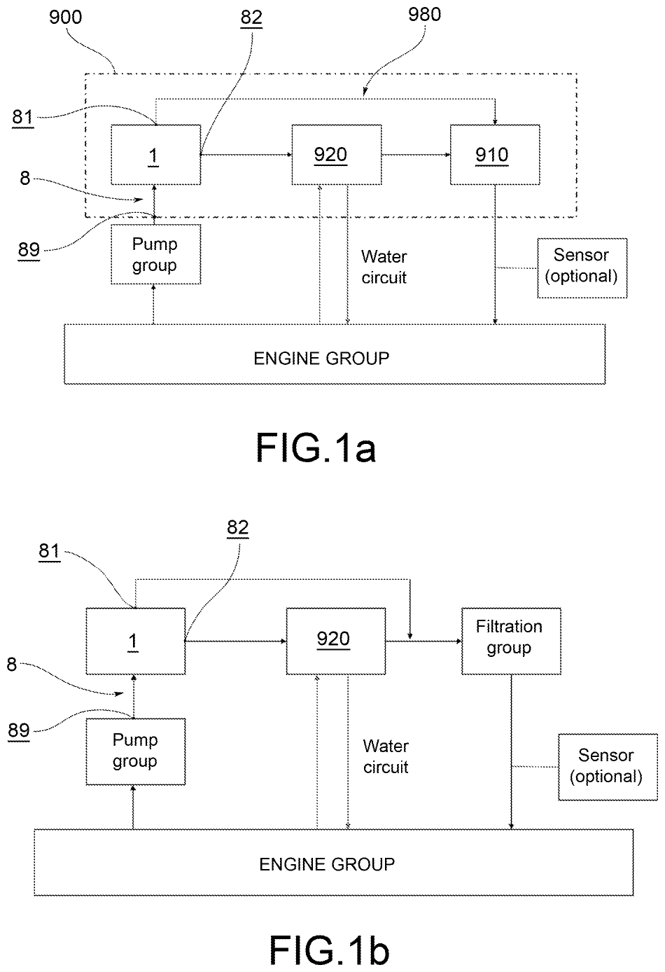

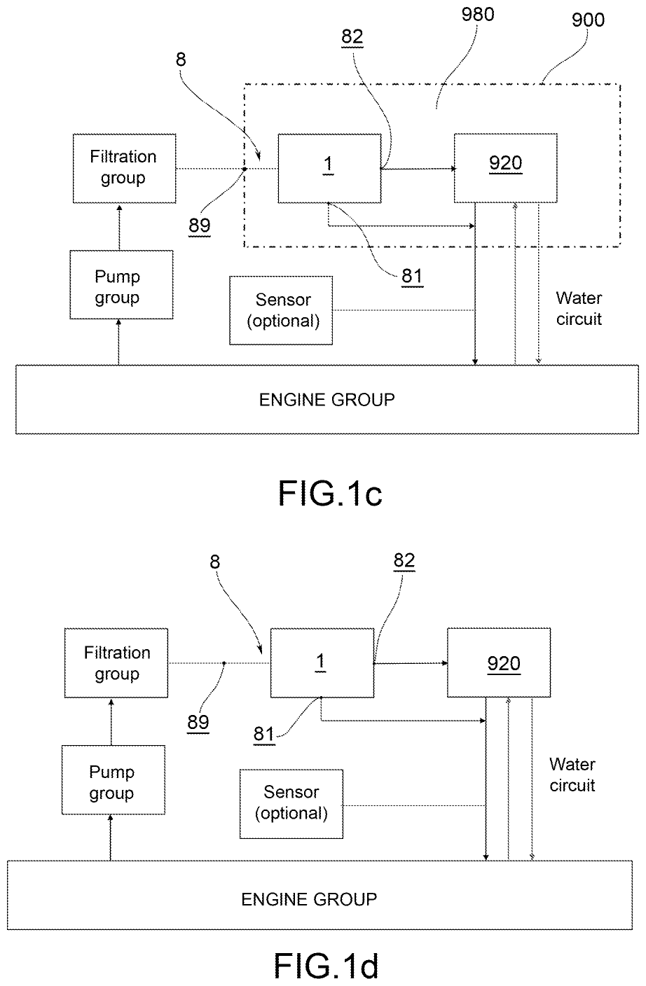

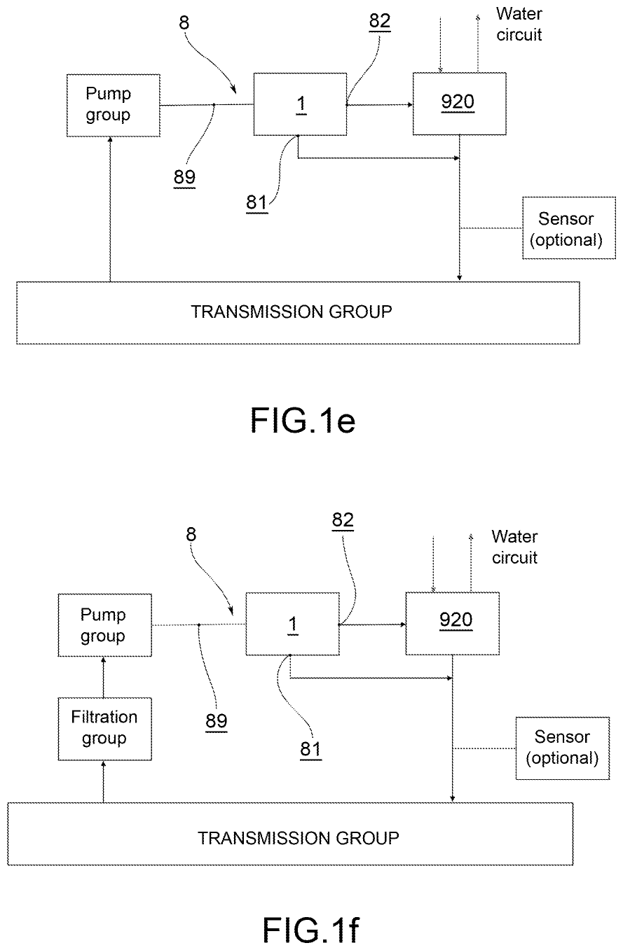

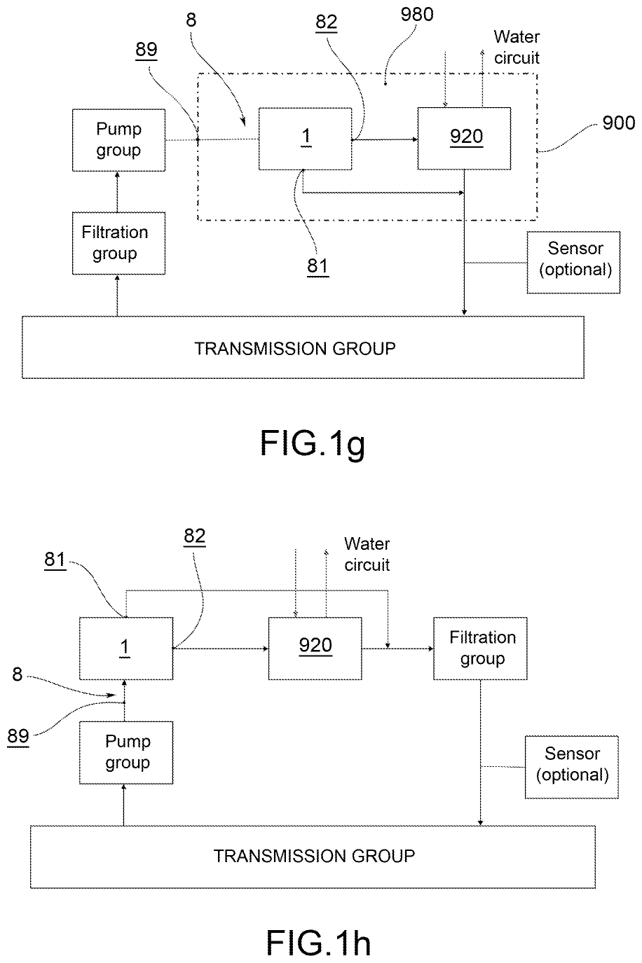

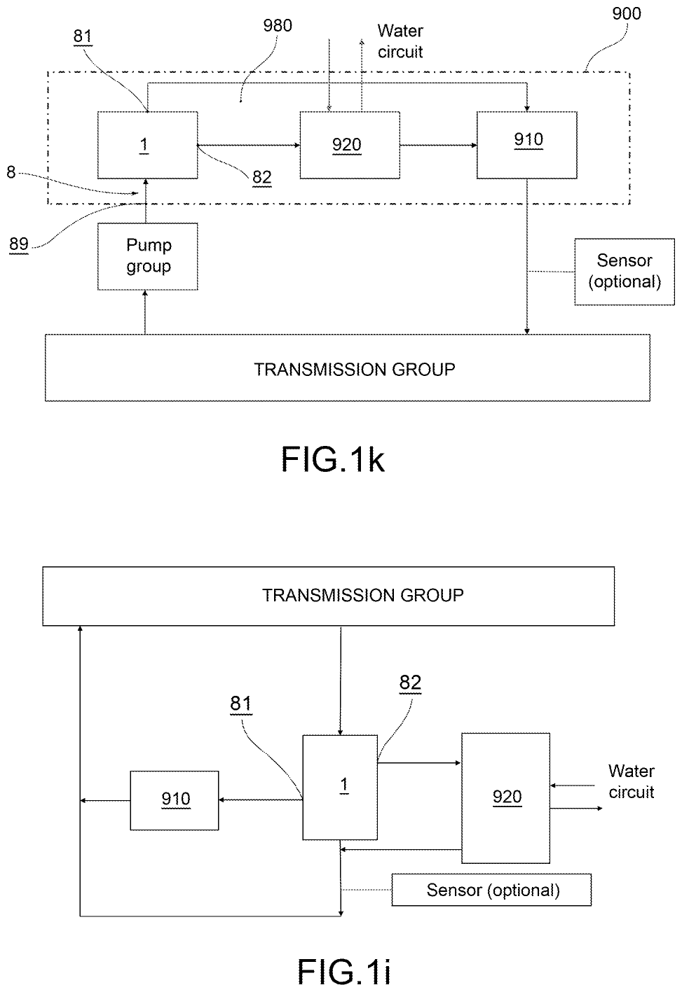

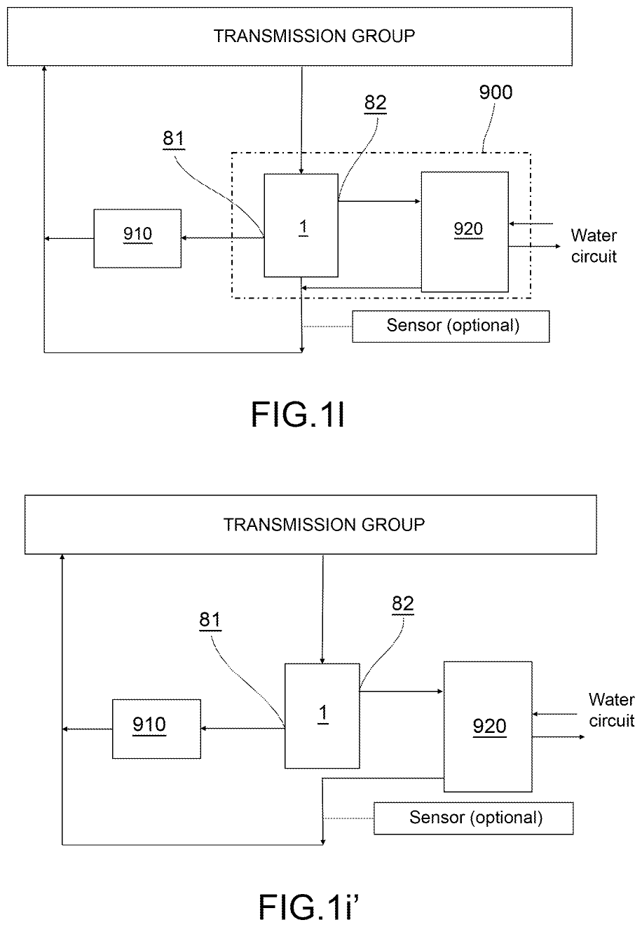

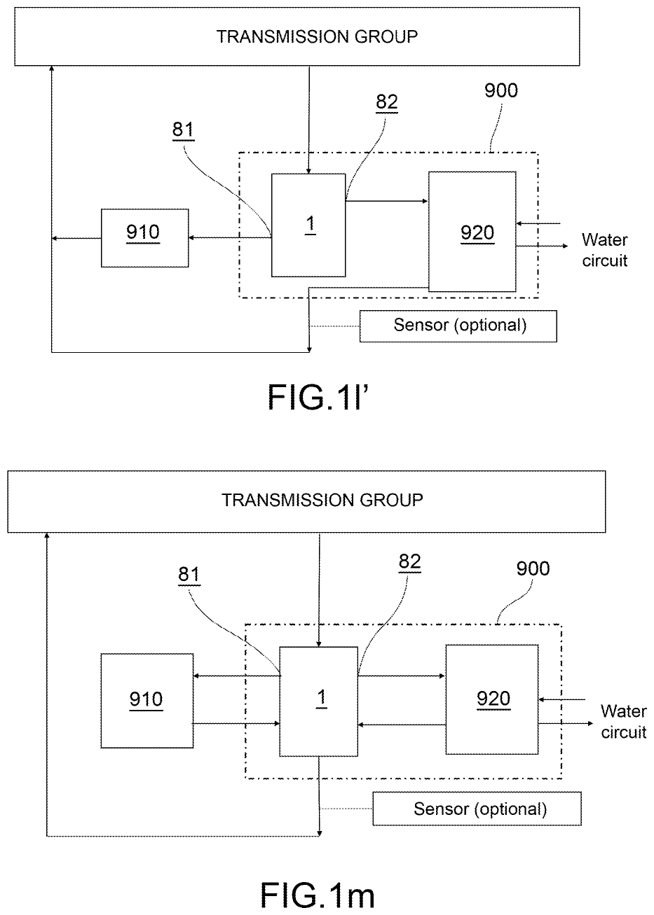

### DETAILED DESCRIPTION

In the accompanying drawings, reference numeral 1 indicates a valve group of the present invention.

Furthermore, in the accompanying drawings, reference numeral 900 indicates an oil management assembly of a vehicle which is in turn the subject of the present invention.

Specifically, the valve group 1 is suitable for being part of a pressurized oil circuit of a vehicle. Thereby, the valve group 1 is suitable for managing the fluid connection of a plurality of operating groups.

According to a preferred embodiment, “operating groups” is intended as a plurality of groups and components of the vehicle, such as the engine group, the transmission group, the gearbox group, but also a filtration group or a heat exchanger group or a pump group. Preferably, operating groups is intended as components designed to perform specific operations of the vehicle, for example for the motion thereof, but at the same time also specific operations on the oil, such as filtration or temperature adjustment operations.

In accordance with the present invention, the valve group 1 is suitable for managing the flow of oil towards a heat exchanger group or towards another vehicle operating group. In some embodiments, said vehicle operating group is a filtration group. In other embodiments, said vehicle operating group is a gearbox group or a transmission group or an engine group, i.e., groups which need to receive a certain amount of pressurized oil to best operate.

In accordance with a preferred embodiment, the oil management assembly 900 is mountable, for example by means of a specially shaped flange, on the engine group, or on the transmission group, or on the gearbox group of a motor vehicle, to be fluidically connected thereto.

According to other preferred embodiments, the oil management assembly 900 is also mountable on other operating groups of the vehicle.

According to a further preferred embodiment, the valve group 1 is suitable to manage the oil flow between two heat exchangers.

Preferably, the valve group 1 is suitable to manage the oil flow towards a first heat exchanger 920, for example an oil/water exchangers adapted to heat oil, or towards a second heat exchangers 910, for example an oil/water exchangers adapted to cold oil.

In accordance with the present invention, the oil management assembly comprises a heat exchanger group 920. In a preferred embodiment, the heat exchanger group 920 is of the plate type suitable for delimiting an alternating succession of passage channels for the coolant (e.g., water and glycol) and for the oil, so that the oil in contact with the plates performs a heat exchange thereto or therefrom, increasing or decreasing the temperature thereof. The present invention is not limited to the type of heat exchanger group.

Furthermore, the oil management assembly 900 comprises a support group 980 and said heat exchanger group 920. Preferably, the support group 980 is fixable to the engine group, or to other operating groups of the vehicle, for example by means of a specially shaped flange.

According to the present invention, the oil management assembly 900 is therefore suitable for fluidically connecting the heat exchanger group 920 and the further operating group of the vehicle.

In accordance with a preferred embodiment, the same oil management assembly 900 comprises said operating group 910 for example in the form of a filtration group 910. In other words, the support group 980 is such as to house, support and above all fluidically connect the heat exchanger group 920 and said filtration group 910.

In accordance with the present invention, the valve group 1 is housable in a conduit 8 which is fluidically connected to a vehicle operating group and to a heat exchanger group 920.

Preferably, said conduit 8 is obtained in the oil management assembly 900. Preferably, said conduit 8 is obtained in the support group 980 of said oil management assembly 900.

According to a preferred embodiment, the conduit 8 extends along a conduit axis C-C.

Preferably, the conduit 8 comprises an inlet mouth 89 fluidically connectable to a circulation conduit of the vehicle oil circuit to allow the oil to enter the conduit 8.

In accordance with a preferred embodiment, the conduit 8 comprises a conduit mouth 85 axially distal from said inlet mouth 89.

Furthermore, the conduit 8 comprises conduit side walls 80.

In addition, the conduit 8 comprises a first conduit opening 81 and a second conduit opening 82 respectively for fluid connection to the vehicle operating group, preferably but not necessarily to the filtration group 910, and said heat exchanger group 920.

The first conduit opening 81 and the second conduit opening 82 are respectively axially spaced apart along the conduit axis C-C.

According to a preferred embodiment, the aforementioned support group 980 is a “solid” component, for example made of aluminum or plastic, and the conduit 8 is obtained therein. In other words, the side walls of the conduit 80 are obtained in said “solid” component.

In accordance with the present invention, the valve group 1 is housable, at least partially, in the conduit 8.

According to a preferred embodiment, the valve group 1 is insertable/extractable as a cartridge in/from the conduit 8 through the conduit mouth 85. Specifically, the valve group 1 is substantially or at least partially insertable in the conduit 8 with a single operation.

The valve group 1 extends in length along an axis X-X. In a configuration of the valve group 1 housed in the conduit 8, said axis X-X corresponds with the conduit axis C-C.

In accordance with the present invention, the valve group 1 comprises a plurality of specific components.

The valve group 1 comprises a valve body 2 extending along the axis X-X. Preferably, the valve body 2 comprises a body cavity 200. The oil is suitable for flowing in said body cavity 200.

In fact, the valve body 2 extends along the axis X-X between a first end 20 through which the oil flows and a second end 25.

Preferably, said first end 20 is the inlet end of the oil in the body cavity 200.

Preferably, said second end 25 is instead a closing end which prevents further oil flow.

In other words, said second end 25 is instead a closing end which prevents the further flow of oil in addition beyond the housing space of the valve group 1 provided in the conduit 8.

According to a preferred embodiment, said second end is an inner wall of the conduit 8 positioned distally from the first end 20 along the axis X-X.

In accordance with the invention, the valve body 2 comprises a first body opening 21 and a second body opening 22 positioned axially spaced apart from one another along the axis X-X.

In a configuration of the valve group 1 housed in the conduit 8, the first body opening 21 and the second body opening 22 face the first conduit opening 81 and the second conduit opening 82.

According to the present invention, the valve body 2 further comprises at least one guide slot 26 extending axially with respect to the axis X-X. The purpose of such a guide slot 26 will be fully described and highlighted in the following.

Preferably, the valve body 2 comprises a plurality of guide slots 26, preferably two guide slots 26, preferably three guide slots 26, angularly equally spaced apart, which extend axially with respect to the axis X-X.

Preferably, each guide slot 26 is laterally delimited by guide walls 260.

In accordance with the present invention, said second end 25 is suitable for engaging, in the embodiments where it is present, the conduit mouth 85 described, sealing it. Preferably, said second end 25 is specially shaped, for example comprising special slots to engage the conduit opening 85 or to be mountable to the support group 980 by specific screw means.

According to a preferred embodiment, said second end 25 comprises a closing wall.

According to a preferred embodiment, the second end comprises and houses a sealing gasket 259 suitable for engaging the side walls of the conduit 80.

In accordance with a preferred embodiment, the valve group 1 comprises a shutter 3.

The shutter 3 extends along the axis X-X, fitted, to be axially movable, onto the valve body 2.

In accordance with a preferred embodiment, the shutter 3 comprises a shutter body 30 fitted, to be axially movable, onto the valve body 2.

According to the present invention, therefore, the shutter 3, in particular the shutter body 30, in a configuration of the valve group 1 housed in the conduit 8, is radially positioned between the valve body 2 and the conduit side walls 80.

The shutter 3 comprises a first shutter opening 31 and a second shutter opening 32.

Preferably, the first shutter opening 31 and the second shutter opening 32 are included in the shutter body 30.

Furthermore, according to the present invention, the shutter 3 comprises a guide element 36 extending radially through the guide slot 26.

Preferably, therefore, the guide element 36, by passing through the guide slot 26, engaging the guiding walls 260, guides the trajectory of the shutter with respect to the axis X-X.

According to a preferred embodiment, the shutter 3 comprises a plurality of guide elements 36 extending radially through each guide slot 26.

In accordance with a preferred embodiment, the guide elements 36 extend radially, mutually engaging, for example inside the body cavity 200, in a central shutter portion 360.

According to a preferred embodiment, each guide slot 26 extends with respect to the axis X-X linearly parallel thereto, so as to guide the shutter 3 in a linear movement, parallel to the axis X-X.

In accordance with an embodiment variant, each guide slot 26 extends with respect to the axis X-X with a curvilinear trend, for example in a spiral, so as to guide the shutter 3 in a roto-translation movement, i.e., along the axis X-X and around the axis X-X. In accordance with such a preferred embodiment, the above-described openings are both axially and angularly spaced from one another with respect to the axis X-X.

According to a preferred embodiment, the shutter 3 is made of plastic material.

According to a preferred embodiment, the shutter body 30 is made of plastic material.

In accordance with the present invention, the valve group 1 comprises a control device 4 engaged to the valve body 2 and to the shutter 3 to control the position of the shutter 3 along the axis X-X.

According to the invention, the control device 4 is suitable for controlling the position of the shutter 3 between a base position in which the hydraulic passage section defined by the alignment of the first shutter opening 31 with the first body opening 21 is greater than or equal to the hydraulic passage section defined by the alignment of the second shutter opening 32 with the second body opening 22, and an adjustment position in which the hydraulic passage section defined by the alignment of the first shutter opening 31 with the first body opening 21 is smaller than the hydraulic passage section defined by the alignment of the second shutter opening 32 and the second body opening 22.

According to a preferred embodiment, in the base position, the flow of oil flowing in the conduit 8 is suitable for flowing more through the first conduit opening 81, towards the vehicle operating group, i.e., towards the engine group, the transmission group or the gearbox group or towards the filtration group or toward a second heat exchanger 910 or in a point of the oil circuit downstream of the heat exchanger 920.

According to a preferred embodiment, in the base position, the flow of oil flowing in the conduit 8 is divided into substantially equal portions towards the vehicle operating group, i.e., towards the engine group, transmission group or gearbox group or towards the filtration group or toward a second heat exchanger 910, and towards the heat exchanger 920.

In accordance with a preferred embodiment, in the adjustment position, the flow of oil flowing in the conduit 8 is suitable for flowing more through the second conduit opening 82, towards the heat exchanger group 920. In such an adjustment position, therefore, the valve group 1 is suitable for control the adjustment of the oil temperature.

In other words, the valve group 1 is suitable for adjusting the preferential direction of oil flow. Preferably, the valve group 1 then adjusts the possible amount of flow towards the operating group or towards the heat exchanger group, as required. According to a preferred embodiment, the outflow command towards one operating group does not inhibit the outflow command towards the other operating group.

However, in accordance with a preferred embodiment, in the base position, the hydraulic section defined by the alignment of the second shutter opening 32 with the second body opening 22 is substantially zero, since the second shutter opening 32 and the second body opening 22 are substantially misaligned, and in the adjustment position the hydraulic passage section defined by the alignment of the first shutter opening 31 with the first body opening 21 is substantially zero, since the first shutter opening 31 and the first body opening 21 are substantially misaligned.

In other words, the valve group 1 is suitable for adjusting the flow with an on-off mode. Preferably, the valve group 1 then adjusts the flow of oil towards an operating group or towards the heat exchanger group.

According to this embodiment, substantially zero hydraulic section means that the passage section defined by the misalignment of the shutter opening with respect to the valve body opening causes an oil flow rate not exceeding 5% of the oil flow which is observed in the case of completely aligned shutter opening and valve body opening.

In accordance with this embodiment, with on/off mode the possibility of any leakage through the related openings is not excluded, depending on the permeability of the components interacting with the valve. In particular, leakage means an oil flow rate which does not exceed 5% of the flow rate observed with the hydraulic passage section completely open.

According to a preferred embodiment, the control device 4 comprises a control member 40 engaged to the valve body 2 and to the shutter 3.

According to a preferred embodiment, the control member 40 is operable as a function of the operating conditions of the oil, so as to position, when necessary, the shutter 3 in the adjustment position, directing oil towards the heat exchanger group 920.

According to a preferred embodiment, the control member 40 is operable as a function of the oil temperature.

According to a preferred embodiment, the control member 40 is operable as a function of the oil pressure.

According to a preferred embodiment, the control member 40 is therefore suitable for being controlled as a function of the detected oil temperature and/or pressure.

In accordance with some preferred embodiments, the control member 40, and therefore the valve group 1, is operatively connected to a specific detection sensor element (for example, temperature and/or pressure). Preferably, said temperature and/or pressure detection element is connected to the circuit and/or to the vehicle operating groups. Preferably, the control member 40, and therefore the valve group, is operatively connected to the electronic control unit ECU of the vehicle.

Preferably, the control member 40, and therefore the valve group, comprises an electrical connector for connecting to the electronic control unit ECU of the vehicle.

Preferably, the control member 40, and therefore the valve group, comprises an electric actuator connected to the electronic control unit ECU of the vehicle by means of wireless technology.

Preferably, the control member 40, and therefore the valve group, is operatively connected to the electronic control unit ECU of the vehicle which enables the operation of the control device 4 based on a parameter (e.g., temperature/pressure) measured by the sensor element in turn operatively connected to the electronic control unit ECU.

In accordance with another preferred embodiment, the control member 40 is suitable for detecting the temperature of the oil and react accordingly.

According to a preferred embodiment, the control member 40 is of the temperature-sensitive type.

Preferably, the control member 40 comprises a wax element 400.

According to a preferred embodiment, the control member 40 is housed in the body cavity 200, engaging the second end 25 and the shutter 3.

In accordance with a preferred embodiment, the control member 40 is housed in the body cavity 200, engaging the second end 25 and the at least one guide element 36.

Preferably, the control member 40 with wax element 400 engages the guide element 36 in a region which is proximal to the axis X-X.

Preferably, the control member 40 with wax element 400 engages the guide elements 36, in the embodiment which comprises a plurality thereof, in the central shutter position 360.

Preferably, the wax element 400 is therefore housed in the body cavity 200.

Preferably, the wax element 400 is positioned near the second end 25

Preferably, the wax element 400 radially faces the first body opening 21.

In accordance with a preferred embodiment, the control member 40 comprises an electric control actuator 410 and a control pin 415 moved axially by the electric control actuator 410.

Preferably, the electric control actuator 410 is an electric motor. Preferably, said electric motor is of the brushless or brushed type.

Preferably, the electric control actuator 410 comprises a solenoid element.

According to such a preferred embodiment, the electric control actuator 410 is housed at the second end 25 and the control pin 415 engages the shutter 3.

According to such a preferred embodiment, the electric control actuator 410 is housed at the second end and the control pin 415 engages the at least one guide element 36.

In accordance with a preferred embodiment, the control pin 415 engages the guide element 36 in a region near the axis X-X.

Preferably, the control pin 415 engages the guide elements 36, in the embodiment comprising a plurality thereof, in the central shutter position 360.

According to a preferred embodiment, the electric control actuator 410 is housed at the second end outside the body cavity 200. For example, preferably, the electric control actuator 410 is located outside the support group 920.

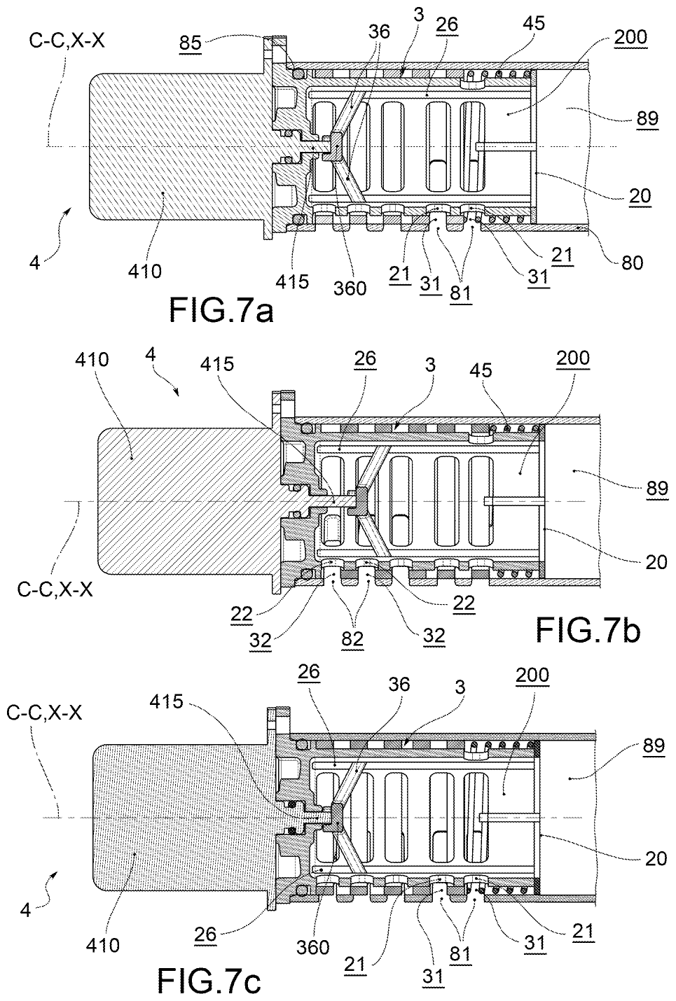

In accordance with a preferred embodiment, in a breakage and/or malfunction condition of the electric control actuator 410, the shutter 3 is positioned in a safety position in which the first shutter opening 31 and the first body opening 21 are at least partially aligned, and the second shutter opening 32 and the second body opening 22 are at least partially aligned. Preferably, therefore, with the broken or malfunctioning electric control actuator 410, the shutter 3 is placed in a failsafe condition, ensuring a predefined inflow of oil both through the second conduit opening 82 and through the first conduit opening 81. Such a situation is shown in FIG. 7c, for example.

According to a preferred embodiment, the control member 40 comprises a shape memory element 420, engaged at one end to the valve body 2 and at the other end to the shutter 3.

In accordance with a preferred embodiment, the shape memory element 420 extends along the axis X-X, fitted onto the valve body 2, so as to be, in a configuration of the valve group 1 housed in the conduit 8, radially positioned between the valve body 2 and the conduit side walls 80, engaging the second end 25 on one side and a first shutter edge 38 on the other side. According to a preferred embodiment, the shape memory element 420 is a helical spring.

In accordance with an alternative embodiment, the control member 40 comprises an electrically powered wax element 400.

Furthermore, in accordance with a preferred embodiment, the control device 4 comprises a return member 45 suitable for performing an action on the shutter 3 which is contrary to that of the control member so as to bring the shutter 3 to the base position.

Furthermore, in accordance with a preferred embodiment, the control device 4 comprises a return member 45 suitable for performing an action on the shutter 3 which is contrary to that of the control member so as to bring the shutter 3 to the safety position.

In accordance with a preferred embodiment, the return member 45 is a spring extending along the axis X-X, fitted, to be axially movable, onto the valve body 2, so as to be, in a configuration of the valve group 1 housed in the conduit 8, radially positioned between the valve body 2 and the conduit side walls 80, engaging at one end an abutment element 20′ placed at the first end and at the other end a second shutter edge 39.

In accordance with a preferred embodiment, the valve body 20 and the shutter 3 have a substantially axially symmetrical extension.

According to the present invention, the term “opening” means an opening through which the oil flows. Specifically, the shape or number of fluid passages which make up the respective opening do not limit the present invention. In fact, as shown for example in the accompanying drawings, a plurality of fluid passages corresponds to an opening.

According to a preferred embodiment, each conduit opening 81, 82, each body opening 21, 22 and each shutter opening 31, 32 consists of a plurality of fluid passages axially spaced apart from one another.

Preferably, each fluid passage extends over a circumferential section with respect to the conduit axis C-C and the axis X-X.

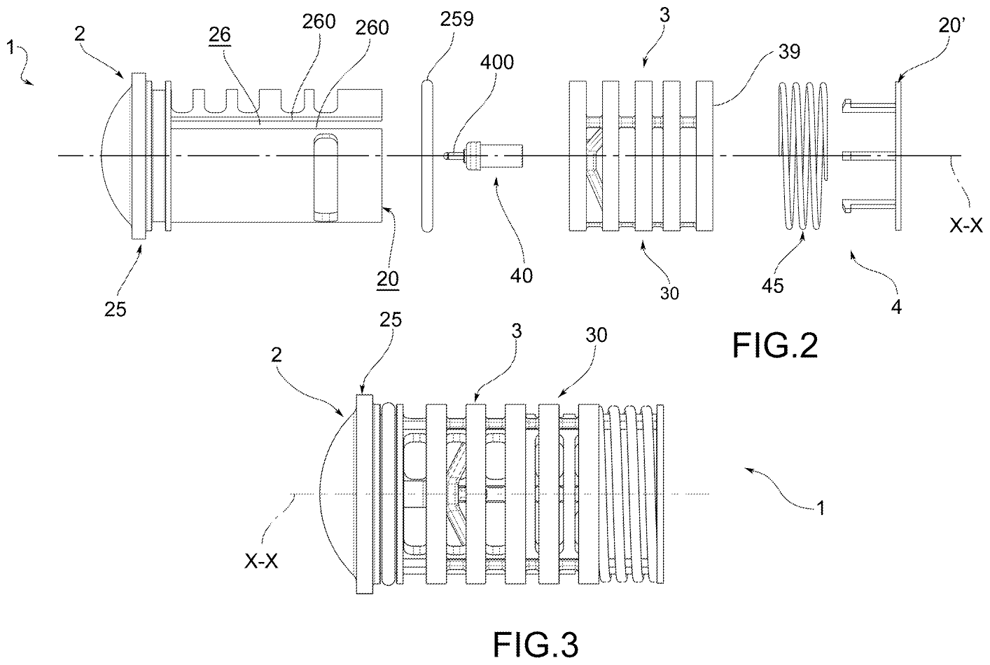

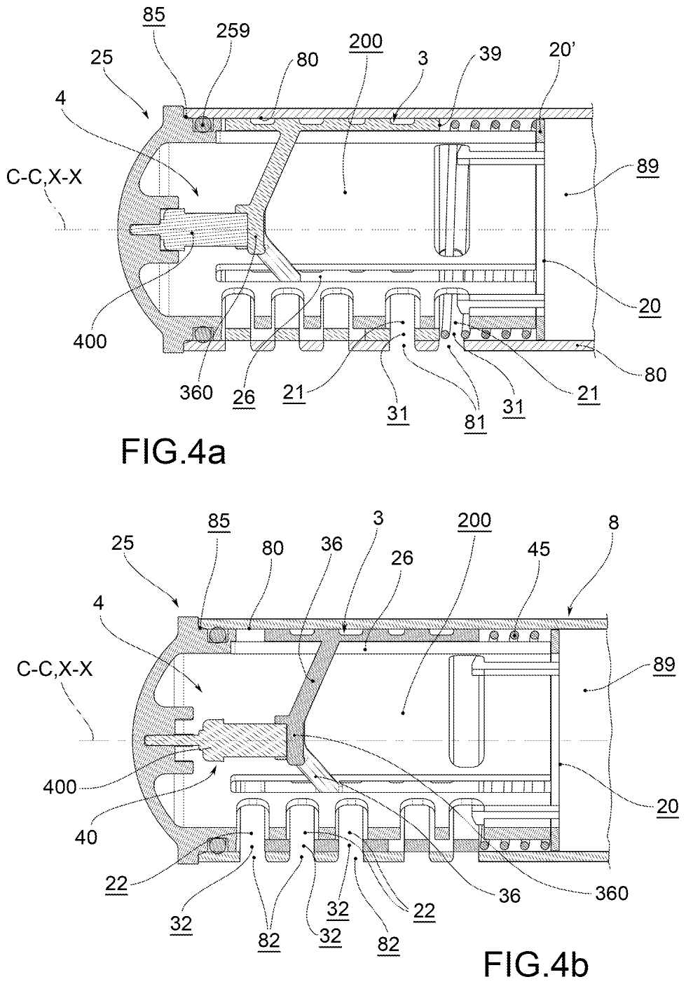

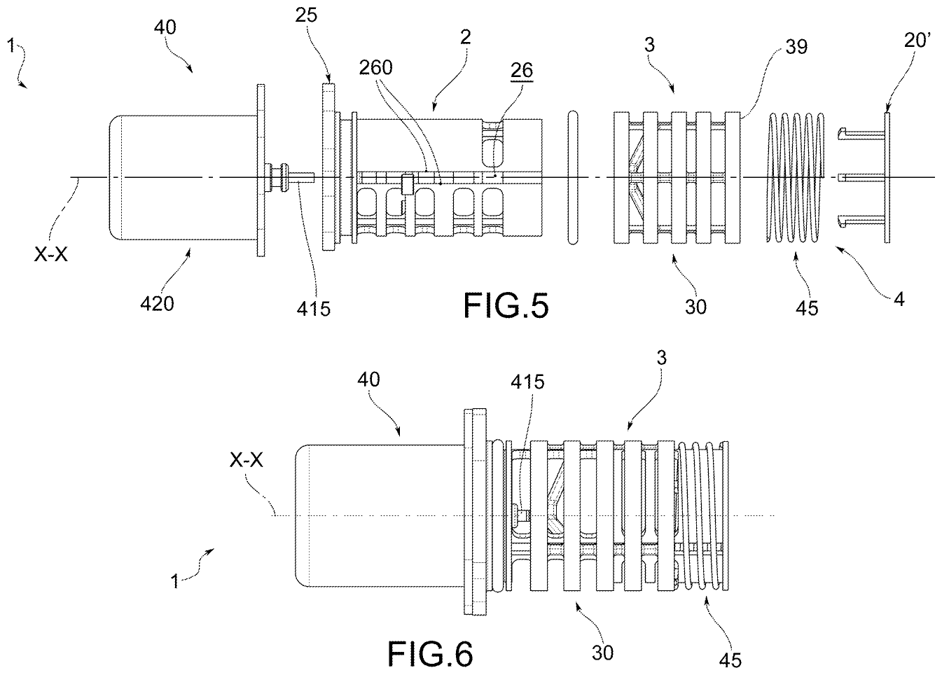

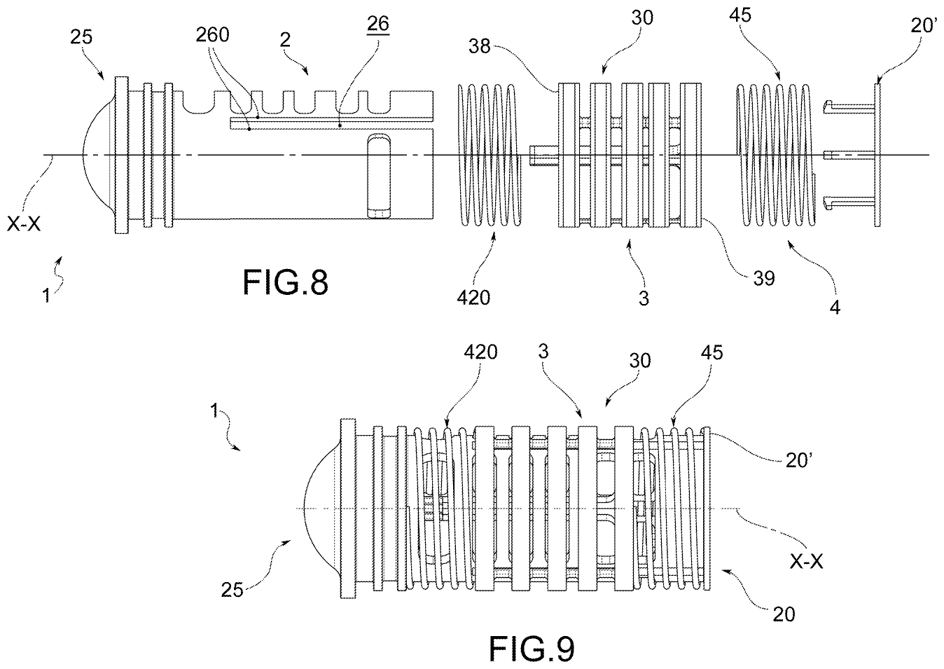

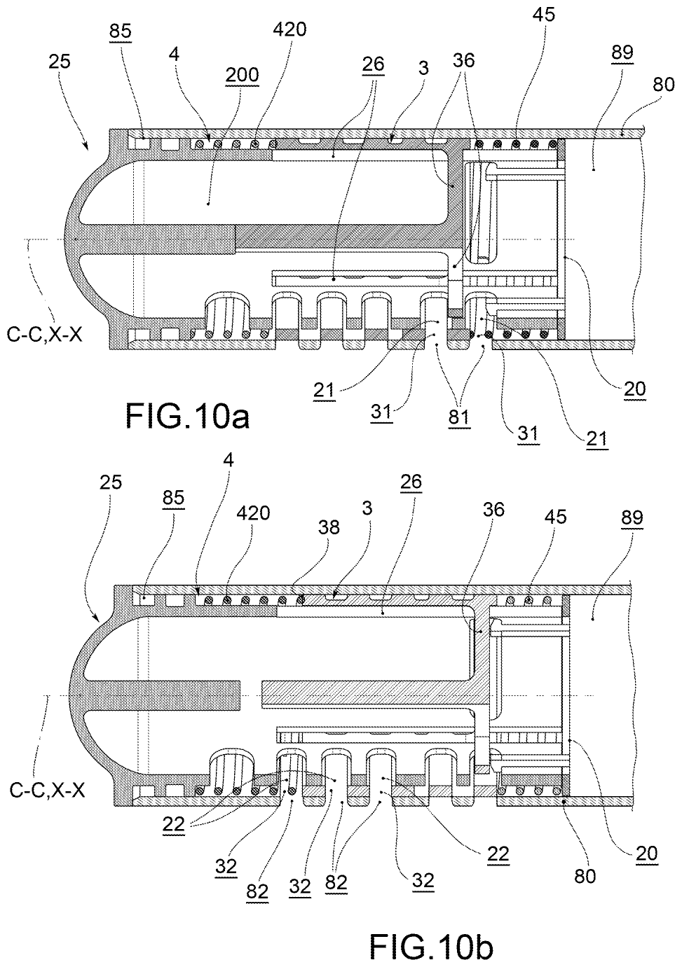

In particular, advantageously, such an embodiment is suitable for adjusting the oil flow with the correspondence of short axial strokes of the shutter, increasing the compactness of the valve group, optimizing the use of the available spaces, and increasing the response time of the valve in managing the oil flow. Such specific embodiments are widely shown in FIGS. 2 to 10.

Innovatively, the valve group, the pressurized oil circuit which comprises it and the oil management assembly which comprises it fully fulfill the purpose of the present invention, overcoming the typical problems of the prior art.

Advantageously, in fact, the valve group is suitable for managing and direct the oil in the best possible manner according to the physical features of the oil, so as to allow the engine and/or gearbox and/or transmission group to always work in optimal conditions.

In particular, by managing the passage of oil through the heat exchanger group, the oil is heated or cooled in a manner such that it is returned to the engine group, the gearbox group, or the transmission group at a desired temperature, preferably optimal.

In fact, advantageously, in an operating condition corresponding to the cold engine group (or gearbox group, or transmission group) in which the oil temperature is too low, the valve group, in the shortest possible time, directs the oil towards the heat exchanger to heat it. In other words, advantageously, the valve group is suitable for controlling the oil according to the temperature thereof so as to accelerate a reheating and thus accelerate the heating step of the engine itself.

Advantageously, the valve group is simple and economical to manufacture.

Advantageously, the valve group is suitable for effectively operating even in the presence of a high viscosity oil.

Advantageously, the valve group is designed so that the components thereof work even when subjected to high stresses.

Advantageously, the shutter group is positionable almost entirely outside the central cavity. Advantageously, the shutter group is protected by the valve body.

Advantageously, the main components of the valve group are arranged so as to not obstruct the circulation of the oil in the inner cavity of the valve body, reducing the pressure drops in the circuit imposed by the presence of the valve without affecting the ability to manage the oil flow.

Advantageously, the shutter is positioned radially between the inner surface of the conduit and the outer surface of the valve body, minimizing the undesirable effect of any dragging forces exerted by the oil, in particular at low temperature (high viscosity), ensuring a better control on the position of the shutter, reducing the stresses on the control device, thus increasing the reliability of the valve group.

Advantageously, the valve body of the valve group is a multifunctional element suitable for supporting both the control device and the shutter while guiding the movement of the shutter by means of guide slots obtained on the valve body itself.

Advantageously, the valve body of the valve group is a multifunctional element suitable for supporting both the control device and the shutter while guiding the movement of the shutter by means of guide slots obtained on the valve body itself and simultaneously closing the end of the housing conduit.

Advantageously, high amounts of oil are adjusted by including minimum shutter strokes.

Advantageously, the oil flow is managed by means of minimum axial shutter strokes, resulting in a simplification of the structure of the control device.

Advantageously, the excursion of the control pin of an electric actuator is minimized, ensuring a greater level of reliability of the valve group and reducing the cost thereof.

Advantageously, the valve group also includes a specific safety function, by including a failsafe function even in the presence of breakages or malfunctions of the electric control actuator, always ensuring a certain flow of oil towards the heat exchanger, avoiding undesired overheating of the circuit and/or a degradation of the properties of the oil.

Advantageously, the valve group, as a function of the application thereof, for example as a function of the type of pressurized oil circuit for which it is intended, for example whether it is in the engine oil or gearbox oil or transmission oil circuit, or whether it is on small or medium-sized motor vehicles, or on industrial vehicles, has the same components mentioned above, varying from one application to another only in size.

Advantageously, the valve group is implementable both on vehicles powered by an internal combustion engine and on vehicles with hybrid or electric power.

Moreover, advantageously, a specific design of the conduit is not necessary since the valve group operates on the oil independently. In other words, it is advantageously unnecessary to provide the conduit with specific shoulders at the different positions of the shutter, since the valve group independently performs the described positions by operating directly with the shutter, modifying the position thereof according to the different operating conditions.

It is apparent that, in order to meet contingent needs, those skilled in the art may make changes to the valve group or the oil circuit or the filtration assembly which are fully contained within the scope of protection as defined by the following claims.

### LIST OF REFERENCE NUMERALS

1 valve group
2 valve body
20 first end
20′ abutment element
21 first body opening
22 second body opening
25 second end
259 sealing gasket
26 guide slot
260 guide walls
200 body cavity
81 first conduit opening
82 second conduit opening
3 shutter
30 shutter body
31 first shutter opening
32 second shutter opening
36 guide element
38 first shutter edge
39 second shutter edge
4 control device
40 control member
400 wax element
410 electric control actuator
415 control pin
420 shape memory element
8 conduit
80 conduit side walls
81 first conduit opening
82 second conduit opening
85 conduit mouth
89 inlet mouth
900 oil management assembly
910 operating group
920 heat exchanger group
980 support group
C-C conduit axis
X-X axis

1. A valve group EH housable in a conduit of a pressurized oil circuit, wherein said conduit is in fluid communication with a vehicle operating group and with a heat exchanger group, wherein said conduit extends along a conduit axis comprising conduit side walls and a first conduit opening and a second conduit openings positioned axially spaced apart on the conduit side walls fluidly connected to the operating group and the heat exchanger group respectively;
wherein the valve group extends in length along an axis coinciding, in a configuration housed in the conduit, with the conduit axis, and comprises:
i) a valve body, comprising a body cavity extending along the axis, between a first end through which the oil entering the body cavity flows and a second end axially spaced apart, wherein the valve body comprises a first body opening and a second body opening positioned axially spaced apart, so a to face, in a configuration of the valve group housed in the conduit, the first conduit opening and the second conduit opening; respectively, wherein the valve body further comprises at least one guide slot extending axially with respect to the axis;
ii) a shutter, extending along the axis, comprising a shutter body fitted, axially movable, onto the valve body, so a to be, in a configuration of the valve group housed in the conduit, radially positioned between the valve body and the conduit side walls, wherein the shutter comprises, on said shutter body, a first shutter opening and a second shutter opening, wherein the shutter comprises a guide element extending radially through the guide slot;
iii) a control device engaged with the valve body and the shutter to control a position of the shutter along the axis between a base position in which a hydraulic passage section defined by alignment of the first shutter opening to the first body opening is greater than or equal to a hydraulic passage section defined by alignment of the second shutter opening with the second body opening, and an adjustment position in which the hydraulic passage section defined by the alignment of the first shutter opening with the first body opening is smaller than the hydraulic passage section defined by the alignment of the second shutter opening with the second body opening.

2. The valve group according to claim 1, wherein in the base position, the hydraulic section defined by the alignment of the second shutter opening with the second body opening is substantially zero, since wherein the second shutter opening and the second body opening are substantially misaligned, and wherein in the adjustment position the hydraulic passage section defined by the alignment of the first shutter opening with the first body opening is substantially zero, wherein the first shutter opening and the first body opening are substantially misaligned.

3. The valve group according to claim 1, wherein each conduit opening, each body opening and each shutter opening comprises a plurality of fluid passages axially spaced apart from one another.

4. The valve group according to claim 1, wherein the valve body comprises a plurality of guide slots angularly equally distanced, extending axially with respect to the axis wherein the shutter comprises a plurality of guide elements extending radially through each guide slot.

5. The valve group according to claim 4, wherein the guide elements extend radially by mutually engaging for example inside the body cavity, in a central shutter portion.

6. The valve, group according to claim 1, wherein the at least one guide slot extends with respect to the axis linearly parallel thereto, so that an action of the control device corresponds to an axial translation of the shutter.

7. The valve group according to claim 1, wherein the control device comprises a control member engaged with the valve body and the shutter, wherein the control member is operable as a function of the operating conditions of the oil, to guide the shutter in the base position or in the adjustment position.

8. The valve group according to claim 7, wherein the control member is temperature-sensitive, wherein the control member is housed in the body cavity engaging the second end and the at least one guide element.

9. The valve group according to claim 7, wherein the control member comprises an electric control actuator and a control pin moved axially by the electric control actuator, wherein said electric control actuator is housed at the second end and the control pin engages the at least one guide element.

10. The valve, group according to claim 9, wherein the electric control actuator is housed at the second end outside the body cavity.

11. The valve group according to claim 9, wherein in a breakage and/or malfunction condition of the electric control actuator, the shutter is positionable in a safety position in which the first shutter opening and the first body opening are at least partially aligned, and the second shutter opening and the second body opening are at least partially aligned.

12. The valve group according to claim 7, wherein the control member comprises a shape memory element, engaged at one end with the valve body and at an other end with the shutter.

13. The valve group according to claim 12, wherein the shape memory element extends along the axis, fitted onto the valve body to be, in a configuration of the valve group housed in the conduit, radially positioned between the valve body and the conduit side walls, engaging the second end on one side and a first shutter edge on the other side.

14. The valve group according to claim 13, wherein the shape memory element is a helical spring.

15. The valve group according to claim 7, wherein the control device comprises a return member adapted to perform an action on the shutter which is contrary to that an action of the control member so as to bring the shutter in the base position.

16. The valve group according to claim 15, wherein in a breakage and/or malfunction condition of the electric control actuator, the shutter is positionable in a safety position in which the first shutter opening, and the first body opening are at least partially aligned, and the second shutter opening and the second body opening are at least partially aligned, and
wherein the return member is adapted to perform an action on the shutter which is contrary to that an action of the control member, to bring the shutter to the safety position.

17. The valve group according to claim 15, wherein the return member is a spring extending along the axis, fitted, to be axially movable, onto the valve body, so as to be, in a configuration of the valve group housed in the conduit, radially positioned between the valve body and the conduit side walls, engaging at one end an abutment element placed in the first end and at the other end a second shutter edge.

18. The valve, group according to claim 1, wherein the valve body and the shutter have a substantially axially symmetrical extension.

19. The valve group according to claim 1, wherein the second end is closed and prevents the flow of oil.

20. The valve group according to claim 19, wherein the conduit comprises a conduit mouth and the second end sealingly engages and closes said conduit mouth, closing it.

21. The valve group according to claim 1, wherein the valve group is insertable/extractable, as a cartridge, from the conduit.

22. A pressurized oil circuit of a vehicle comprising the valve group, according to claim 1.

23. An oil management assembly of a pressurized oil circuit of a vehicle fluidly connected to a vehicle operating group, comprising:
a heat exchanger group;
a support assembly comprising at least one conduit extending along a conduit axis comprising conduit side walls comprising a first conduit opening and a second conduit opening for the fluid connection with the operating group and said heat exchanger group, respectively;
a valve group which is housable in said conduit, according to claim 1.

24. A vehicle oil management assembly which is fluidly connectable to a vehicle operating group, comprising a vehicle gearbox assembly or engine assembly, comprising:
an oil filtration group supported and fluidly connected to the support assembly by means of the conduit, wherein the first conduit opening is fluidly connected to said oil filtration assembly.

25. The valve group according to claim 1, wherein each conduit opening, each body opening and each shutter opening comprise a plurality of fluid passages axially spaced apart from one another, wherein each fluid passage extends over a circumferential section with respect to the conduit axis and the axis.

26. The valve group according claim 1, wherein the valve body comprises two guide slots, angularly equally distanced, extending axially with respect to the axis, wherein the shutter comprises a plurality of guide elements extending radially through each guide slot.

27. The valve group according claim 1, wherein the valve body comprises three guide slots, angularly equally distanced, extending axially with respect to the axis, wherein the shutter comprises a plurality of guide elements extending radially through each guide slot.

28. The valve group according to claim 4, wherein the guide elements extend radially by mutually engaging inside the body cavity in a central shutter portion.

29. The valve group according to claim 7, wherein the control member is temperature-sensitive and comprises a wax element, wherein the control member is housed in the body cavity, engaging the second end and the at least one guide element.

30. An oil management assembly of a pressurized oil circuit of a vehicle fluidly connected to a vehicle engine assembly, or to a transmission assembly, comprising:
a heat exchanger group;
a support assembly comprising at least one conduit extending along a conduit axis comprising conduit side walls comprising a first conduit opening and a second conduit opening for the fluid connection with the operating group and said heat exchanger group, respectively;
a valve group which is housable in said conduit, according to claim 1.
